(19) United States
(12) Patent Application Publication
(10) Pub. No.: US 2003/0221000 A1
(43) Pub. Date: Nov. 27, 2003

(54) System and method for measuring web service performance using captured network packets

(76) Inventors: Ludmila Cherkasova, Sunnyvale, CA (US); Yun Fu, Durham, NC (US); Wenting Tang, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/146,967

(22) Filed: May 16, 2002

(51) Int. Cl. G06F 15/173

(52) U.S. Cl. 709/224; 709/203

(57) ABSTRACT

According to one embodiment of the present invention, a method is provided for measuring performance of service provided to a client by a server in a client-server network. The method comprises capturing network-level information for a client access of data from a server in a client-server network, wherein the client-server network comprises a server side and a client side and wherein the network-level information is captured on the server side. The method further comprises determining from the captured network-level information at least one performance measurement relating to the client access of data.

### CROSS-REFERENCE TO RELATED APPLICATIONS

This application is related to concurrently filed and commonly assigned U.S. patent application Ser. No. ______ entitled “SYSTEM AND METHOD FOR RECONSTRUCTING CLIENT WEB PAGE ACCESSES FROM CAPTURED NETWORK PACKETS”, concurrently filed and commonly assigned U.S. patent application Ser. No. ______ entitled “KNOWLEDGE-BASED SYSTEM AND METHOD FOR RECONSTRUCTING CLIENT WEB PAGE ACCESSES FROM CAPTURED NETWORK PACKETS”, concurrently filed and commonly assigned U.S. patent application Ser. No. ______ entitled “SYSTEM AND METHOD FOR COLLECTING DESIRED INFORMATION FOR NETWORK TRANSACTIONS AT THE KERNEL LEVEL”, and concurrently filed and commonly assigned U.S. patent application Ser. No. ______ entitled “SYSTEM AND METHOD FOR RELATING ABORTED CLIENT ACCESSES OF DATA TO QUALITY OF SERVICE PROVIDED BY A SERVER IN A CLIENT-SERVER NETWORK”, the disclosures of which are hereby incorporated herein by reference.

### FIELD OF THE INVENTION

The present invention relates in general to client-server networks, and more specifically to a system and method for measuring the performance of providing a web service to a client using information from captured network packets.

### BACKGROUND OF THE INVENTION

Today, Internet services are delivering a large array of business, government, and personal services. Similarly, mission critical operations, related to scientific instrumentation, military operations, and health services, are making increasing use of the Internet for delivering information and distributed coordination. For example, many users are accessing the Internet seeking such services as personal shopping, airline reservations, rental car reservations, hotel reservations, on-line auctions, on-line banking, stock market trading, as well as many other services being offered via the Internet. Many companies are providing such services via the Internet, and are therefore beginning to compete in this forum. Accordingly, it is important for such service providers (sometimes referred to as “content providers”) to provide high-quality services.

One measure of the quality of service provided by service providers is the end-to-end performance characteristic. The end-to-end performance perceived by clients is a major concern of service providers. In general, the end-to-end performance perceived by a client is a measurement of the time from when the client requests a service (e.g., a web page) from a service provider to the time when the client fully receives the requested service. For instance, if a client requests to access a service provided by a service provider, and it takes several minutes for the service to be downloaded from the service provider to the client, the client may consider the quality of the service as being poor because of its long download time. In fact, the client may be too impatient to wait for the service to fully load and may instead attempt to obtain the service from another provider. Currently, most website providers set a target client-perceived end-to-end time of less than six seconds for their web pages. That is, website providers typically like to provide their requested web pages to a client in less than six seconds from the time the client requests the page.

A popular client-server network is the Internet. The Internet is a packet-switched network, which means that when information is sent across the Internet from one computer to another, the data is broken into small packets. A series of switches called routers send each packet across the network individually. After all of the packets arrive at the receiving computer, they are recombined into their original, unified form. TCP/IP is a protocol commonly used for communicating the packets of data. In TCP/IP, two protocols do the work of breaking the data into packets, routing the packets across the Internet, and then recombining them on the other end: 1) the Internet Protocol (IP), which routes the data, and 2) the Transmission Control Protocol (TCP), which breaks the data into packets and recombines them on the computer that receives the information. TCP/IP is well known in the existing art, and therefore is not described in further detail herein.

One popular part of the Internet is the World Wide Web (which may be referred to herein simply as the “web”). Computers (or “servers”) that provide information on the web are typically called “websites.” Services offered by service providers' websites are obtained by clients via the web by downloading web pages from such websites to a browser executing on the client. For example, a user may use a computer (e.g., personal computer, laptop computer, workstation, personal digital assistant, cellular telephone, or other processor-based device capable of accessing the Internet) to access the Internet (e.g., via a conventional modem). A browser, such as NETSCAPE NAVIGATOR developed by NETSCAPE, INC. and MICROSOFT INTERNET EXPLORER developed by MICROSOFT CORPORATION, as examples, may be executing on the user's computer to enable a user to input information requesting to access a particular website and to output information (e.g., web pages) received from an accessed website.

In general, a web page is typically composed of a mark-up language file, such as a HyperText Mark-up Language (HTML), Extensible Mark-up Language (XML), Handheld Device Mark-up Language (HDML), or Wireless Mark-up Language (XML) file, and several embedded objects, such as images. A browser retrieves a web page by issuing a series of HyperText Transfer Protocol (HTTP) requests for all objects. As is well known, HTTP is the underlying protocol used by the World Wide Web. The HTTP requests can be sent through one persistent TCP connection or multiple concurrent connections.

As described above, service providers often desire to have an understanding of their end-to-end performance characteristics. Effectively monitoring and characterizing the end-to-end behavior of web transactions is important for evaluating and/or improving the web site performance and selecting the proper web site architecture for a service provider to implement. Because in this forum the client-perceived website responses are downloaded web pages, the performance related to web page downloading is one of the critical elements in evaluating end-to-end performance. However, the nature of the Internet and the manner in which services are provided via the web result in difficulty in acquiring meaningful performance measurements. For instance, the best effort nature of Internet data delivery, changing client and network connectivity characteristics, and the highly complex architectures of modern Internet services makes it very difficult to understand the performance characteristics of Internet services. In a competitive landscape, such understanding is critical to continually evolving and engineering Internet services to match changing demand levels and client populations.

Two popular techniques exist in the prior art for benchmarking the performance of Internet services: 1) the active probing technique, and 2) the web page instrumentation technique. The active probing technique uses machines from fixed points in the Internet to periodically request one or more Uniform Resource Locators (URLs) from a target web service, record end-to-end performance characteristics, and report a time-varying summary back to the web service. For example, in an active probing technique, artificial clients may be implemented at various fixed points (e.g., at fifty different points) within a network, and such artificial clients may periodically (e.g., once every hour or once every 15 minutes) request a particular web page from a website and measure the end-to-end performance for receiving the requested web page at the requesting artificial client. A number of companies use active probing techniques to offer measurement and testing services, including KEYNOTE SYSTEMS, INC. (see http://www.keynote.com), NETMECHANIC, INC. (see http://www.netmechanics.com), SOFTWARE RESEARCH INC. (see http://www.soft.com), and PORIVO TECHNOLOGIES, INC. (see http://www.porivo.com).

The active probing techniques are based on periodic polling of web services using a set of geographically distributed, synthetic clients. In general, only a few pages or operations can typically be tested, potentially reflecting only a fraction of all user's experience with the services of a given web service provider. Further, active probing techniques typically cannot capture the potential benefits of browser's and network caches, in some sense reflecting “worst case” performance. From another perspective, active probes comprise a different set of machines than those that actually access the service. For example, the artificial clients used for probing a website may comprise different hardware and/or different network connectivity than that of typical end users of the website. For instance, most users of a particular website may have a dial-up modem connection (e.g., using a 56 kilobyte modem) to the Internet, while the artificial clients used for probing may have direct connections, cable modem connections, Integrated Services Digital Network (ISDN) connections, or Digital Subscriber Line (DSL) connections. Thus, there may not always be correlation in the performance/reliability reported by the probing service and that experienced by actual end users.

Finally, it is difficult to determine the breakdown between network and server-side performance using active probing, making it difficult for service providers to determine where best to place their optimization efforts. That is, active probing techniques indicate the end-to-end performance measurement for a web page, but it does not indicate the amount of latency that is attributable to the web server and the amount of latency that is attributable to the network. For instance, a service provider may be unable to alter the latency caused by congestion on the network, but the service provider may be able to evaluate and improve its server's performance if much of the latency is due to the server (e.g., by decreasing the number of processes running on the server, redesigning the web page, altering the web server's architecture, etc.). Further, this active probing technique does not provide any information on the impact of network and client browser's caching. For instance, it does not provide a computation of the percentage of files and bytes delivered from the server compared with the total files/bytes required for delivering a particular web service.

The second technique for measuring performance, the web page instrumentation technique, associates code (e.g., JAVASCRIPT) with target web pages. The code, after being downloaded into the client browser, tracks the download time for individual objects and reports performance characteristics back to the web site. That is, in this technique, instrumentation code embedded in web pages and downloaded to the client is used to record access times and report statistics back to the server. For example, a web page may be coded to include instructions that are executable to measure the download time for objects of the web page. Accordingly, when a user requests the web page, the coded instrumentation portion of the web page may first be downloaded to the client, and such instrumentation may execute to measure the time for the client receiving each of the other objects of the web page.

As an example, WEB TRANSACTION OBSERVER (WTO) from HEWLETT PACKARD's OPENVIEW suite uses JAVASCRIPT to implement such a web page instrumentation technique (see e.g., http://www.openview.hp.com/). With additional web server instrumentation and cookie techniques, this product can record the server processing time for a request, enabling a breakdown between server and network processing time. A number of other products and proposals employ similar techniques, such as the TIVOLI WEB MANAGEMENT SOLUTIONS available from IBM CORPORATION (see http://www.tivoli.com/products/demos/twsm.html), CANDLE CORPORATION's EBUSINESS ASSURANCE (see http://www.candle.com/), and “Measuring Client-Perceived Response Times on the WWW” by R. Rajamony and M. Elnozahy at Proceedings of the Third USENIX Symposium on Internet Technologies and Systems (USITS), Mar. 2001, San Francisco.

Because the web page instrumentation technique downloads instrumentation code to actual clients, this technique can capture end-to-end performance information from real clients, as opposed to capturing end-to-end performance information for synthetic (or “artificial”) clients, as with the above-described active probing techniques. However, the web page instrumentation technique fails to capture connection establishment times (because the instrumentation code is not downloaded to a client until after the connection has been established), which are potentially an important aspect of overall performance. Further, there is a certain amount of resistance in the industry to the web page instrumentation technique. The web page instrumentation technique requires additional server-side instrumentation and dedicated resources to actively collect performance reports from clients. For example, added instrumentation code is required to be included in a web page to be monitored, thus increasing the complexity associated with coding such web page and introducing further potential for coding errors that may be present in the web page (as well as further code maintenance that may be required for the web page). Additionally, this technique does not provide an analysis of how to deal with server/network portions of the latency in case of pipelined and concurrent connections. Further, this technique does not provide any information on the impact of network and client browser's caching. For instance, it does not provide a computation of the percentage of files and bytes delivered from the server compared with the total files/bytes required for delivering a particular web service.

### BRIEF SUMMARY OF THE INVENTION

According to one embodiment of the present invention, a method is provided for measuring performance of service provided to a client by a server in a client-server network. The method comprises capturing network-level information for a client access of data from a server in a client-server network, wherein the client-server network comprises a server side and a client side and wherein the network-level information is captured on the server side. The method further comprises determining from the captured network-level information at least one performance measurement relating to the client access of data.

### BRIEF DESCRIPTION OF THE DRAWINGS

For a more complete understanding of the present invention, reference is now made to the following descriptions taken in conjunction with the accompanying drawing, in which:

FIG. 1 shows an example client-server system in which embodiments of the present invention may be implemented;

FIG. 2 shows the well-known Open System Interconnection (OSI) model for a network framework;

FIG. 3 shows an example operational flow diagram of a preferred embodiment of the present invention;

FIG. 4 shows a block diagram of an example implementation for reconstructing client web page accesses from transactions and using network-level information for such transactions to determine performance data for such accesses in accordance with one embodiment of the present invention;

FIG. 5 shows an example operational flow for implementing operational block 303 of FIG. 3 for determining performance data for a web page access in accordance with one embodiment of the present invention;

FIG. 6 shows an example of a simplified scenario where a 1-object page is downloaded by the client;

FIG. 7 shows an example of a pipelining group consisting of two requests, and the corresponding network-related portion and server processing time in the overall response time;

FIG. 8 shows an example of concurrent connections and the corresponding timestamps;

FIG. 9A shows a graph illustrating the end-to-end response time for accesses to index. html on an hourly scale during a month measured during a case study;

FIG. 9B shows a graph illustrating the number of resent packets in the response stream to clients for accesses to index. html during the case study of FIG. 9A;

FIG. 10A shows a graph illustrating the number of page accesses to itanium.html during a case study;

FIG. 10B shows a graph illustrating the percentage of accesses to itanium.html with end-to-end response time above 6 seconds during the case study of FIG. 10A;

FIG. 11A shows a graph illustrating the server file hit ratio for client accesses of itanium.html during the case study of FIG. 10A;

FIG. 11B shows a graph illustrating the server byte hit ratio for client accesses of itanium.html during the case study of FIG. 10A;

FIG. 12A shows a graph illustrating the average end-to-end response time as measured by a preferred embodiment when downloading the main page of a Support site during a case study;

FIG. 12B shows a graph illustrating the network-server time ratio in the overall response time of the case study of FIG. 12A;

FIG. 13 shows a graph illustrating the connection setup time of the case study of FIG. 12A measured by a preferred embodiment;

FIG. 13B shows a graph illustrating the estimated percentage of end-to-end response time improvement available from running an HTTP 1.1 server in the case study of FIG. 12A;

FIG. 14A shows a graph illustrating the 20 largest client clusters in the case study of FIG. 12A by Autonomous Systems;

FIG. 14B shows a graph that reflects the corresponding average end-to-end response time per Autonomous System of FIG. 14A;

FIG. 15 shows an example of a solution that is deployed as a network appliance for reconstructing web page accesses and measuring the performance of such accesses;

FIG. 16 shows an example of a solution that is deployed as software on a web server for reconstructing web page accesses and measuring the performance of such accesses;

FIG. 17 shows an example of a solution for reconstructing web page accesses and measuring the performance of such accesses in which a portion of the solution is deployed as software on a web server and a portion of the solution is deployed as software on an independent node; and

FIG. 18 shows an example computer system on which embodiments of the present invention may be implemented.

### DETAILED DESCRIPTION OF THE INVENTION

As described above, service providers in a client-server network (e.g., website providers) often desire to have an understanding of their client-perceived end-to-end performance characteristics. That is, service providers often desire to have an understanding of their client-perceived performance in providing information (e.g., web pages) to clients. One performance measurement that is often desired is the client-perceived end-to-end performance in receiving information from a server. Such end-to-end performance may comprise a measurement of time from a client requesting the desired data (e.g., a web page) to the client fully receiving such desired data. In the web forum, the client-perceived end-to-end performance is the client-perceived time for downloading a requested web page from a website. Accordingly, the performance related to web page downloading is one of the critical elements in evaluating end-to-end performance of website providers. Therefore, a desire exists for a system and method that provide accurate measurement of end-to-end performance in providing desired data (e.g., a web page) from a server to a client in a client-server network.

Further, a desire exists for a system and method that are capable of measuring performance (e.g., end-to-end performance) on the server side of the client-server network. Also, a desire exists for a system and method that are capable of determining the portion of the end-to-end performance that is attributable to server latency (e.g., server processing time) and the portion of the end-to-end performance that is attributable to network latency. Additionally, a desire exists for a system and method that are capable of determining the impact of caching (e.g., network and browser caching) on the end-to-end performance of providing desired data from a server to a client.

Various embodiments of the present invention are now described with reference to the above figures, wherein like reference numerals represent like parts throughout the several views. As described further below, embodiments of the present invention use captured network-level information (e.g., network packets) for client accesses of desired data to determine performance data (e.g., the end-to-end performance) for such client accesses. Preferably, such network-level information is captured on the server side of the client-server network. As end-to-end performance is often an important measurement for evaluating the service provider's quality of service (QoS), a preferred embodiment determines at least the end-to-end performance measurement of a client access. As described further below, certain embodiments of the present invention are capable of determining the portion of the end-to-end performance that is attributable to server latency and the portion that is attributable to network latency. Accordingly, latency in satisfying a client access of server information (e.g., a web page) resulting from 1) server-related performance issues (e.g., high web server processing time for a web page due, for example, to server overload) and 2) network-related performance issues (e.g., high network transfer time for a web page due, for example, to network congestion and/or low bandwidth available to a client) may be determined. Further, certain embodiments of the present invention are capable of determining the impact of caching on the end-to-end performance of providing desired data (e.g., a web page) from a server to a client. Of course, in alternative embodiments various other performance measurements for a client access of server information (e.g., a web page) may be determined in addition to or instead of the above-identified performance measurements.

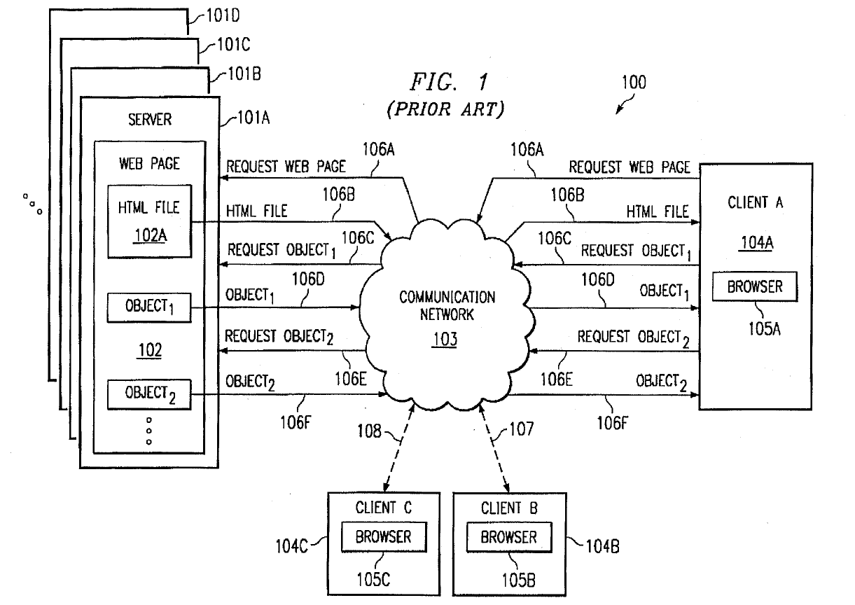

Turning to FIG. 1, an example client-server system 100 is shown in which embodiments of the present invention may be implemented. As shown, one or more servers 101A-101D may provide services (information) to one or more clients, such as clients A-C (labeled 104A-104C, respectively), via communication network 103. Communication network 103 is preferably a packet-switched network, and in various implementations may comprise, as examples, the Internet or other Wide Area Network (WAN), an Intranet, Local Area Network (LAN), wireless network, Public (or private) Switched Telephony Network (PSTN), a combination of the above, or any other communications network now known or later developed within the networking arts that permits two or more computers to communicate with each other.

In a preferred embodiment, servers 101A-101D comprise web servers that are utilized to serve up web pages to clients A-C via communication network 103 in a manner as is well known in the art. Accordingly, system 100 of FIG. 1 illustrates an example of servers 101A-101D serving up web pages, such as web page 102, to requesting clients A-C. Of course, embodiments of the present invention are not limited in application to measuring performance of client accesses of web pages, but may instead be implemented for measuring performance of client accesses of other types of information provided by a server. Thus, while various examples are provided herein for measuring performance (e.g., end-to-end performance) of client accesses of web pages, it should be understood that such examples are intended to render the disclosure enabling for measuring performance of client accesses of various other types of server information.

In the example of FIG. 1, web page 102 comprises an HTML (or other mark-up language) file 102A (which may be referred to herein as a “main page”), and several embedded objects (e.g., images, etc.), such as Object₁, and Object₂. Techniques for serving up such web page 102 to requesting clients A-C are well known in the art, and therefore such techniques are only briefly described herein. In general, a browser, such as browsers 105A-105C, may be executing at a client computer, such as clients A-C. To retrieve a desired web page 102, the browser issues a series of HTTP requests for all objects of the desired web page. For instance, various client requests and server responses are communicated between client A and server 101A in serving web page 102 to client A, such as requests/responses 106A-106F (referred to collectively herein as requests/responses 106). Requests/responses 106 provide a simplified example of the type of interaction typically involved in serving a desired web page 102 from server 101A to client A. As those of skill in the art will appreciate, requests/responses 106 do not illustrate all interaction that is involved through TCP/IP communication for serving a web page to a client, but rather provides an illustrative example of the general interaction between client A and server 101A in providing web page 102 to client A.

When a client clicks a hypertext link (or otherwise requests a URL) to retrieve a particular web page, the browser first establishes a TCP connection with the web server by sending a SYN packet (not shown in FIG. 1). If the server is ready to process the request, it accepts the connection by sending back a second SYN packet (not shown in FIG. 1) acknowledging the client's SYN. At this point, the client is ready to send HTTP requests 106 to retrieve the HTML file 102A and all embedded objects (e.g., Object₁, and Object₂), as described below.

First, client A makes an HTTP request 106A to server 101A for web page 102 (e.g., via client A's browser 105A). Such request may be in response to a user inputting the URL for web page 102 or in response to a user clicking on a hyperlink to web page 102, as examples. Server 101A receives the HTTP request 106A and sends HTML file 102A (e.g., file “index.html”) of web page 102 to client A via response 106B. HTML file 102A typically identifies the various objects embedded in web page 102, such as Object₁, and Object₂. Accordingly, upon receiving HTML file 102A, browser 105A requests the identified objects, Object₁ and Object₂, via requests 106C and 106E. Upon server 101A receiving the requests for such objects, it communicates each object individually to client A via responses 106D and 106F, respectively. As illustrated by the generic example of FIG. 1, each object of a requested web page is retrieved from a server by an individual HTTP request made by the client. A client request and corresponding server response (e.g., HTTP request-response pair) may be referred to collectively herein as a “transaction” (e.g., an HTTP transaction).

Again, the above interactions are simplified to illustrate the general nature of requesting a web page, from which it should be recognized that each object of a web page is requested individually by the requesting client and is, in turn, communicated individually from the server to the requesting client. The above requests/responses 106 may each comprise multiple packets of data. Further, the HTTP requests can, in certain implementations, be sent from a client through one persistent TCP connection with server 101A, or, in other implementations, the requests may be sent through multiple concurrent connections. Server 101A may also be accessed by other clients, such as clients B and C of FIG. 1, and various web page objects may be communicated in a similar manner to those clients through packet communication 107 and 108, respectively.

In general, the client-perceived end-to-end performance for receiving web page 102 is measured from the time that the client requests web page 102 to the time that the client receives all objects of the web page (i.e., receives the full page). However, HTTP does not provide any means to delimit the beginning or the end of a web page. For instance, HTTP is a stateless protocol in which each HTTP request is executed independently without any knowledge of the requests that came before it. Accordingly, it is difficult at a server side 101A to reconstruct a web page access for a given client without parsing the original HTML file.

Certain embodiments of the present invention enable a passive technique for measuring end-to-end performance of web page accesses using captured network-level information. Certain embodiments of the present invention enable a passive technique for reconstructing client web page accesses from captured network-level information, and the reconstructed client web page accesses may then be used to measure their respective end-to-end performance. For instance, network packets acquired by a network-level capture tool, such as the well-known UNIX tcpdump tool, may be used to determine (or reconstruct) a client's web page access. From such reconstruction of the client's web page access, the client-perceived end-to-end response time for a web page download may be determined. Thus, various embodiments of the present invention enable a passive, end-to-end monitor that is operable to measure performance of client web page accesses using captured network-level information.

The “network level” may be better understood with reference to the well-known Open System Interconnection (OSI) model, which defines a networking framework for implementing protocols in seven layers. The OSI model is a teaching model that identifies functionality that is typically present in a communication system, although in some implementations two or three OSI layers may be incorporated into one. The seven layers of the OSI model are briefly described hereafter in conjunction with FIG. 2. According to the OSI model, data 203 is communicated from computer (e.g., server) 201 to computer (e.g., client) 202 through the various layers. That is, control is passed from one layer to the next, starting at the application layer 204 in computer 201, proceeding to the bottom layer, over the channel to computer 202, and back up the hierarchy.

In general, application layer 204 supports application and end-user processes. Communication partners are identified, quality of service is identified, user authentication and privacy are considered, and any constraints on data syntax are identified. This layer provides application services for file transfers, e-mail, and other network software services. For example, a client browser executes in application layer 204.

According to the OSI model, presentation layer 205 provides independence from differences in data representation (e.g., encryption) by translating from application to network format, and vice versa. Presentation layer 205 works to transform data into the form that the application layer 204 can accept. This layer 205 formats and encrypts data to be sent across a network, providing freedom from compatibility problems. It is sometimes called the “syntax layer.”

Session layer 206 of the OSI model establishes, manages and terminates connections between applications. Session layer 206 sets up, coordinates, and terminates conversations, exchanges, and dialogues between the applications at each end of the communication. It deals with session and connection coordination. Transport layer 207 of the OSI model provides transparent transfer of data between end systems, or hosts, and is responsible for end-to-end error recovery and flow control. It ensures complete data transfer.

Network layer 208 of the OSI model provides switching and routing technologies, creating logical paths, such as virtual circuits, for transmitting data from node to node. Thus, routing and forwarding are functions of this layer 208, as well as addressing, internetworking, error handling, congestion control, and packet sequencing.

At data link layer 209 of the OSI model, data packets are encoded and decoded into bits. This layer furnishes transmission protocol knowledge and management and handles errors in the physical layer 210, flow control and frame synchronization. Data link layer 209 may be divided into two sublayers: 1) the Media Access Control MAC) sublayer, and 2) the Logical Link Control (LLC) sublayer. The MAC sublayer controls how a computer on the network gains access to the data and permission to transmit it. The LLC sublayer controls frame synchronization, flow control and error checking.

Physical layer 210 conveys the bit stream (e.g., electrical impulse, light, or radio signal) through the communication network at the electrical and mechanical level. It provides the hardware means of sending and receiving data on a carrier, including defining cables, cards and physical aspects. Fast Ethernet, RS232, and ATM are example protocols with components of physical layer 210.

As described above, one technique for measuring client-perceived end-to-end performance is the web page instrumentation technique in which instrumentation code is included in a web page and is downloaded from the server to a client. More specifically, in this technique, the web page instrumentation code for a web page is downloaded from a server to the client and is executed by the client's browser (in the application layer 204) to measure the end-to-end time for downloading the web page to the client. Accordingly, such web page instrumentation technique captures information at the application layer 204 for measuring client-perceived end-to-end performance. As described further below, embodiments of the present invention preferably utilize information captured at the network layer 208 to reconstruct client web page accesses, thereby eliminating the requirement of including instrumentation in a web page for measuring end-to-end performance. Thus, embodiments of the present invention enable a server (or other node(s) properly positioned on the communication network) to reconstruct information regarding client web page accesses from captured network layer information (e.g., captured network packets).

Another technique utilized in the prior art for measuring end-to-end performance is the active probing technique. As described above, the active probing technique utilizes artificial clients to actively probe a particular web page (i.e., by actively accessing the particular web page) on a periodic basis and measure the response time for receiving the requested web page. As described further below, embodiments of the present invention preferably provide a passive technique that is capable of utilizing captured network-level information to reconstruct actual client web page accesses. Accordingly, rather than actively probing web pages from artificial clients, embodiments of the present invention preferably enable passive monitoring of web page accesses by actual clients to measure the client-perceived end-to-end performance for such web pages.

Accordingly, embodiments of the present invention enable actual client web page accesses to be reconstructed without requiring instrumentation code to be included in a web page for monitoring a client's access of such web page (as is required in the web page instrumentation technique). Also, embodiments of the present invention enable actual client web page accesses to be reconstructed, as opposed to monitoring artificial clients as in the active probing technique. Further, embodiments of the present invention provide a passive monitoring technique that enables actual network-level information (e.g., packets) to be captured and used for reconstructing client web page accesses, as opposed to actively probing web pages as in the active probing technique. Thus, a web page provider may utilize an embodiment of the present invention to passively reconstruct web page accesses for measuring the client-perceived end-to-end performance for such accesses through captured network-level information from the actual client accesses, rather than actively accessing the web page from “test” client(s) in order to measure the end-to-end performance perceived by the “test” client(s).

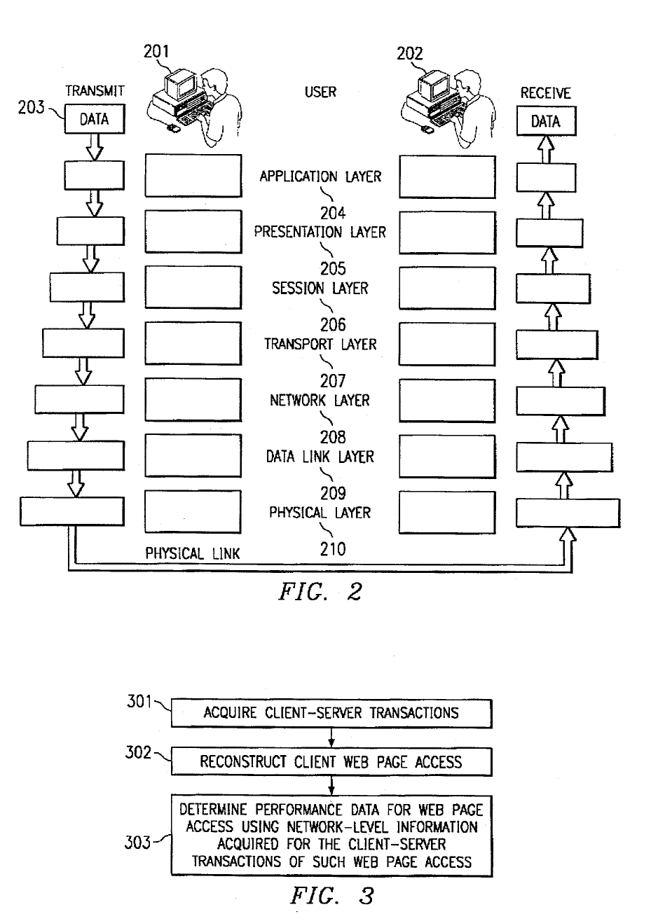

Turning to FIG. 3, an example operational flow diagram of a preferred embodiment of the present invention is shown. In operational block 301, client-server transactions are acquired. For example, information relating to client-server transactions, such as transactions 106 of FIG. 1, may be collected. Preferably, a Transaction Log, as described further below, is generated that comprises collected information relating to client-server transactions. In operational block 302, a client access of a server (e.g., a client web page access) is reconstructed. For example, as described with FIG. 1 above, a client access of a web page may comprise a plurality of separate transactions. Thus, in operational block 302, the various transactions that comprise a given client access of a server (e.g., of a web page) may be related together. Preferably, a Web Page Session Log, as described further below, is generated that comprises collected information for transactions organized by the web page access to which the transactions correspond.

In operational block 303, performance data is determined for the reconstructed client access. Such performance data is determined using network-level information acquired for the client-server transactions of such web page access. For instance, the collected transaction information, such as the example information of Table 1 described below, for the transactions that comprise the reconstructed client access may be used to determine various performance measurements relating to such client access. For example, the overall end-to-end performance of such client access may be determined. Further, the server latency (e.g., due to server processing) in satisfying such client access may be determined, and the network latency (e.g., due to network congestion) during such client access may be determined. Also, the caching efficiency in satisfying such client access may be determined. For instance, the number of files and/or bytes for satisfying the client access that are actually retrieved from the server, as opposed to being retrieved from a cache (e.g., browser cache or network cache) may be determined.

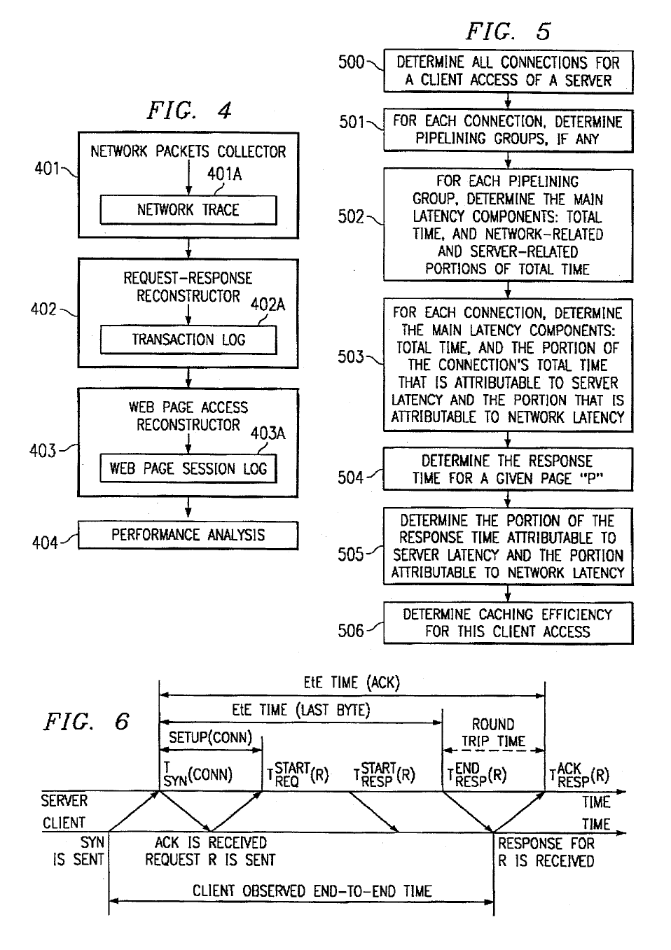

FIG. 4 shows a block diagram of an example implementation for reconstructing client web page accesses from transactions and using captured network-level information for such accesses to determine performance data for such accesses in accordance with one embodiment of the present invention. As shown, this example embodiment comprises network packets collector module 401, request-response reconstructor module 402 (which may be referred to herein as transaction reconstructor module 402), and web page access reconstructor module 403. As described further hereafter, performance analysis module 404 is included for performing performance analysis (e.g., measuring client-perceived end-to-end performance) for web page accesses. Examples of reconstructing client web page accesses from client-server transactions that may be implemented in accordance with embodiments of the present invention are described in greater detail in concurrently filed and commonly assigned U.S. patent application Ser. No. ______ entitled “SYSTEM AND METHOD FOR RECONSTRUCTING CLIENT WEB PAGE ACCESSES FROM CAPTURED NETWORK PACKETS” and in concurrently filed and commonly assigned U.S. patent application Ser. No. ______ entitled “KNOWLEDGE-BASED SYSTEM AND METHOD FOR RECONSTRUCTING CLIENT WEB PAGE ACCESSES FROM CAPTURED NETWORK PACKETS”, the disclosures of which are incorporated herein by reference.

In this example embodiment, network packets collector module 401 is operable to collect network-level information that is utilized to reconstruct web page accesses. More specifically, in this example embodiment, network packets collector module 401 utilizes a tool to capture network packets, such as the publicly available UNIX tool known as “tcpdump” or the publicly available WINDOWS tool known as “WinDump.” The software tools “tcpdump” and “WinDump” are well-known and are commonly used in the networking arts for capturing network-level information for network “sniffer/analyzer” applications. Typically, such tools are used to capture network-level information for monitoring security on a computer network (e.g., to detect unauthorized intruders, or “hackers”, in a system). Of course, other tools now known or later developed for capturing network-level information, or at least the network-level information utilized by embodiments of the present invention, may be utilized in alternative embodiments of the present invention.

Network packets collector module 401 records the captured network-level information (e.g., network packets) to a Network Trace file 401A. This approach allows the Network Trace 401A to be processed in offline mode. For example, tcpdump may be utilized to capture many packets (e.g., a million packets) for a given period of time (e.g., over the course of a day), which may be compiled in the Network Trace 401A. Thereafter, such collected packets in the Network Trace 401A may be utilized by request-response reconstructor module 402 in the manner described further below. While this example embodiment utilizes a tool, such as tcpdump, to collect network information for offline processing, known programming techniques may be used, in alternative embodiments, to implement a real-time network collection tool. If such a real-time network collection tool is implemented in network packets collector module 401, the various other modules of FIG. 4 may be similarly implemented to use the real-time captured network information to reconstruct web page accesses (e.g., in an on-line mode of operation).

From the Network Trace 401A, request-response reconstructor module 402 reconstructs all TCP connections and extracts HTTP transactions (e.g., a request with the corresponding response) from the payload of the reconstructed TCP connections. More specifically, in one embodiment, request-response reconstructor module 402 rebuilds the TCP connections from the Network Trace 401A using the client IP addresses, client port numbers and the request (response) TCP sequence numbers. Within the payload of the rebuilt TCP connections, the HTTP transactions may be delimited as defined by the HTTP protocol. Meanwhile, the timestamps, sequence numbers and acknowledged sequence numbers may be recorded for the corresponding beginning or end of HTTP transactions. After reconstructing the HTTP transactions, request-response reconstructor module 402 may extract HTTP header lines from the transactions. The HTTP header lines are preferably extracted from the transactions because the payload does not contain any additional useful information for reconstructing web page accesses, but the payload requires approximately two orders of magnitude of additional storage space. The resulting outcome of extracting the HTTP header lines from the transactions is recorded to a Transaction Log 402A, which is described further below. That is, after obtaining the HTTP transactions, request-response reconstructor module 402 stores some HTTP header lines and other related information from Network Trace 401A in Transaction Log 402A for future processing (preferably excluding the redundant HTTP payload in order to minimize storage requirements). A methodology for rebuilding HTTP transactions from TCP-level traces was proposed by Anja Feldmann in “BLT: Bi-Layer Tracing of HTTP and TCP/IP”, Proceedings of WWW-9, May 2000, the disclosure of which is hereby incorporated herein by reference. Balachander Krishnamurthy and Jennifer Rexford explain this mechanism in more detail and extend this solution to rebuild HTTP transactions for persistent connections in “Web Protocols and Practice: HTTP/1.1, Networking Protocols, Caching, and Traffic Measurement” pp. 511-522, Addison Wesley, 2001, the disclosure of which is also hereby incorporated herein by reference. Accordingly, in this example embodiment, request-response reconstructor module 402 uses such methodology for rebuilding HTTP transactions from TCP-level traces.

In an alternative embodiment, Transaction Log 402A may be generated in a kernel-level module implemented on the server as described in greater detail in concurrently filed and commonly assigned U.S. patent application Ser. No. ______ titled “SYSTEM AND METHOD FOR COLLECTING DESIRED INFORMATION FOR NETWORK TRANSACTIONS AT THE KERNEL LEVEL,” the disclosure of which is hereby incorporated herein by reference. Such alternative embodiment may be desired because, for example, it enables information for transactions to be collected at the kernel level of a server (e.g., a web server), which may avoid rebuilding the transactions at the user level as in the methodology proposed by Anja Feldmann. Such alternative embodiment may enable greater computing efficiency in generating Transaction Log 402A because the transactions are not required to be reconstructed at the user level, and/or it may require less storage space because only the desired information for transactions may be communicated from the kernel level to the user level as opposed to the raw network information of Network Trace 401A being stored at the user level (which may include much more information than is desired for each transaction), as described further in the above-referenced U.S. Patent Application “SYSTEM AND METHOD FOR COLLECTING DESIRED INFORMATION FOR NETWORK TRANSACTIONS AT THE KERNEL LEVEL.”

Once Transaction Log 402A is generated (e.g., either from Network Trace 401A or from a kernel level module), the transactions thereof may be related to their corresponding client web page access. As described above, a web page is generally composed of one HTML file and some embedded objects, such as images or JAVASCRIPTs. When a client requests a particular web page, the client's browser should retrieve all the page-embedded images from a web server in order to display the requested page. The client browser retrieves each of these embedded images separately. As illustrated by the generic example of FIG. 1, each object of a requested web page is retrieved from a server by an individual HTTP request made by the client. An HTTP request-response pair may be referred to collectively herein as an HTTP “transaction.” Entries of Transaction Log 402A contain information about these individual HTTP transactions (i.e., requests/responses).

Thus, once information about various individual HTTP transactions is collected in Transaction Log 402A, the next step in reconstructing a web page access is to relate the different individual HTTP transactions in the sessions corresponding to a particular web page access. That is, the various different HTTP transactions collected in Transaction Log 402A are related together as logical web pages. In the example embodiment of FIG. 4, web page access reconstructor module 403 is responsible for grouping the underlying physical object retrievals together into logical web pages, and stores them in Web Page Session Log 403A. More specifically, web page access reconstructor module 403 analyzes Transaction Log 402A and groups the various different HTTP transactions that correspond to a common web page access. Thus, Web Page Session Log 403A comprises the HTTP transactions organized (or grouped) into logical web page accesses. Again, an example implementation of web page reconstructor module 403 is described in greater detail in concurrently filed and commonly assigned U.S. patent application Ser. No. ______ entitled “SYSTEM AND METHOD FOR RECONSTRUCTING CLIENT WEB PAGE ACCESSES FROM CAPTURED NETWORK PACKETS” and in concurrently filed and commonly assigned U.S. patent application Ser. No. ______ entitled “KNOWLEDGE-BASED SYSTEM AND METHOD FOR RECONSTRUCTING CLIENT WEB PAGE ACCESSES FROM CAPTURED NETWORK PACKETS”, the disclosures of which are incorporated herein by reference.

After different request-response pairs (i.e., HTTP transactions) are grouped into web page retrieval sessions in Web Page Session Log 403A, performance analysis module 404 may be utilized in accordance with various embodiments of the present invention to determine performance measurements for web page accesses. As described further hereafter, various performance measurements may be determined by performance analysis module 404, such as the overall end-to-end performance, server performance, network performance, and caching efficiency of a web page access.

It should be recognized that information acquired for client-server transactions (in Transaction Log 401A) may be used to determine performance measurements for client web page accesses. While Transaction Log 401A may comprise any desired network information in various implementations of alternative embodiments, Table 1 below describes in greater detail the format of an entry in HTTP Transaction Log 401 A of a preferred embodiment of the present invention.

TABLE 1

| Field | Value |
|---|---|
| URL | The URL of the transaction. |
| Referer | The value of the header field Referer, |
| | if it exists. |
| Content Type | The value of the header field Content-Type |
| | in the responses. |
| Flow ID | A unique identifier to specify the TCP |
| | connection of this transaction. |
| Source IP | The client's IP address. |
| Request Length | The number of bytes of the HTTP request. |
| Response Length | The number of bytes of the HTTP response. |
| Content Length | The number of bytes of HTTP response body. |
| Request SYN timestamp | The timestamp of the SYN packet from |
| | the client. |
| Request Start timestamp | The timestamp for receipt of the first byte of |
| | the HTTP request. |
| Request End timestamp | The timestamp for receipt of the last byte of the |
| | HTTP request. |
| Start of Response | The timestamp when the first byte of response |
| | is sent by the server to the client |
| End of Response | The time stamp when the last byte of response |
| | is sent by the server to the client |
| ACK of Response | The ACK packet from the client for the last |
| Timestamp | byte of the HTTP response. |
| Response Status | The HTTP response status code. |
| Via Field | Identification of whether the HTTP |
| | field Via is set. |
| Aborted | Identification of whether the transaction |
| | is aborted. |
| Resent Request Packets | The number of packets resent by the client. |
| Resent Response Packet | The number of packets resent by the server. |

The first field provided in the example Transaction Log entry of Table 1 is the URL field, which stores the URL for the HTTP transaction (e.g., the URL for the object being communicated to the client in such transaction). The next field in the entry is the Referer field. As described above with FIG. 1, typically when a web page is requested, an HTML file 102A is first sent to the client, such as a file “index.html”, which identifies the object(s) to be retrieved for the web page, such as Object₁, and Object₂ in the example of FIG. 1. When the objects for the requested web page (e.g., Object₁, and Object₂) are retrieved by the client via HTTP transactions (in the manner described above with FIG. 1), the Referer field identifies that those objects are embedded in (or are part of) the requested web page (e.g., the objects are associated with the index.html file in the above example). Accordingly, when transactions for downloading various different objects have the same Referer field, such objects belong to a common web page. The HTTP protocol defines such a Referer field, and therefore, the Referer field for a transaction may be taken directly from the captured Network Trace information for such transaction. More specifically, in the HTTP protocol, the referer request-header field allows the client to specify, for the server's benefit, the address (URI) of the resource from which the Request-URI was obtained (i.e., the “referrer”, although the header field is misspelled). The referer request-header allows a server to generate lists of back-links to resources for interest, logging, optimized caching, etc. In view of the above, the Referer field of a transaction directly identifies the web page to which the object of such transaction corresponds.

The next field provided in the example entry of Table 1 is the Content Type field, which identifies the type of content downloaded in the transaction, such as “text/html” or “image/jpeg”, as examples. The next field in the entry is Flow ID, which is a unique identifier to specify the TCP connection of this transaction. The next field in the entry is Source IP, which identifies the IP address of a client to which information is being downloaded in the transaction.

The next field in the example entry of Table 1 is the Request Length field, which identifies the number of bytes of the HTTP request of the transaction. Similarly, the Response Length field is included in the entry, which identifies the number of bytes of the HTTP response of the transaction. The Content Length field is also included, which identifies the number of bytes of the body of the HTTP response (e.g., the number of bytes of an object being downloaded to a client).

The next field in the example entry of Table 1 is the Request SYN timestamp, which is the timestamp of the SYN packet from the client. As described above, when a client clicks a hypertext link (or otherwise requests a URL) to retrieve a particular web page, the browser first establishes a TCP connection with the web server by sending a SYN packet. If the server is ready to process the request, it accepts the connection by sending back a second SYN packet acknowledging the client's SYN. Only after this connection is established can the true request for a web page be sent to the server. Accordingly, the Request SYN timestamp identifies when the first attempt to establish a connection occurred. This field may be used, for example, in determining the latency breakdown for a web page access to evaluate how long it took for the client to establish the connection with the server.

The next field in the entry is the Request Start timestamp, which is the timestamp for receipt of the first byte of the HTTP request of the transaction. Accordingly, this is the timestamp for the first byte of the HTTP request that is received once the TCP connection has been established with the server. The Request End timestamp is also included as a field in the entry, which is the timestamp for receipt of the last byte of the HTTP request of the transaction.

The next field in the entry is the Start of Response field, which identifies the timestamp when the first byte of the response is sent by the server to the client. The entry next includes an End of Response field, which identifies the timestamp when the last byte of the response is sent by the server to the client. The next field in the entry is ACK of Response timestamp, which is the timestamp of the ACK packet (acknowledge packet) from the client for the last byte of the HTTP response of the transaction. As an example, the Request Start timestamp, Request End timestamp, and ACK of Response timestamp fields may be used (e.g., by performance analysis module 403) in measuring the end-to-end performance perceived by the client for a web page access in certain implementations.

The next field in the example entry of Table 1 is the Response Status field, which is the HTTP response status code. For example, the response status code may be a “successful” indication (e.g., status code “200” in HTTP) or an “error” indication (e.g., status code “404” in HTTP). Typically, upon receiving a client's request for a web page (or object embedded therein), the web server provides a successful response (having status code “200”), which indicates that the web server has the requested file and is downloading it to the client, as requested. However, if the web server cannot find the requested file, it may generate an error response (having status code “404”), which indicates that the web server does not have the requested file.

The next field in the example entry of Table 1 is the Via field, which is typically set by a proxy of a client. If the client request is received by the server from a proxy, then typically proxies add their request field in the Via field. Thus, the Via field indicates that in fact its not the original client who requested this file, or who is making this request, but rather it is the proxy acting on behalf of the client.

The next field in the example entry of Table 1 is the Aborted field, which indicates whether the current transaction was aborted. For example, the Aborted field may indicate whether the client's TCP connection for such transaction was aborted. Various techniques may be used to detect whether the client's TCP connection with the server and the current transaction, in particular, is aborted, such as those described further in concurrently filed and commonly assigned U.S. patent application Ser. No. ______ entitled “SYSTEM AND METHOD FOR RELATING ABORTED CLIENT ACCESSES OF DATA TO QUALITY OF SERVICE PROVIDED BY A SERVER IN A CLIENT-SERVER NETWORK”, the disclosure of which is incorporated herein by reference.

The next field in the entry is the Resent Request Packets field, which provides the number of packets resent by the client in the transaction. The Resent Response Packet field is the final field in the entry, which provides the number of packets resent by the server in the transaction. These fields may provide information about the network status during the transaction. For instance, if it was necessary for the server to re-send multiple packets during the transaction, this may be a good indication that the network was very congested during the transaction.

As described in conjunction with FIG. 4 above, some fields of the HTTP Transaction Log entry may be used to rebuild web pages (e.g., via web page access reconstructor module 402), such as the URL, Referer, Content Type, Flow ID, Source IP, Request Start timestamp, and Response End timestamp fields. Examples of reconstructing web page accesses in this manner are further described in concurrently filed and commonly assigned U.S. patent application Ser. No. ______ entitled “SYSTEM AND METHOD FOR RECONSTRUCTING CLIENT WEB PAGE ACCESSES FROM CAPTURED NETWORK PACKETS” and concurrently filed and commonly assigned U.S. patent application Ser. No. ______ entitled “KNOWLEDGE-BASED SYSTEM AND METHOD FOR RECONSTRUCTING CLIENT WEB PAGE ACCESSES FROM CAPTURED NETWORK PACKETS.” Other fields of the HTTP Transaction Log entry may be used to determine performance measurements (e.g., end-to-end performance) for a web page access. For example, the Request Start timestamp and the Response End timestamp fields can be used together to calculate the end-to-end response time. The number of resent packets can reflect the network condition.

As an example of network-level information that may be captured and used to populate certain of the above fields of Table 1, consider the following example requests and responses (transaction) for retrieving “index.html” page with the embedded image “imgl.jpg” from a web server “www.hpl.hp. com”:

Transaction 1:

| | |
|---|---|
| Request: | Get/index.html HTTP/1.0 |
| | Host: www.hpl.hp.com |
| Response: | HTTP/1.0 200 OK |
| | Content-Type: text/html |

Transaction 2:

| | |
|---|---|
| Request: | Get/imgl.jpg HTTP/1.0 |
| | Host: www.hpl.hp.com |
| | Referer: http://www.hpl.hp.com/index.html |
| Response: | HTTP/1.0 200 OK |
| | Content-Type: image/jpeg |

In the above example, the first request is for the HTML file index.html. The content-type field in the corresponding response shows that it is an HTML file (i.e., content type of “text/html”). Then, the next request is for the embedded image imgl.jpg. The request header field referer indicates that the image is embedded in index.html. The corresponding response shows that the content type for this second transaction is an image in jpeg format (i.e., content type of “image/jpeg”). It should be noted that both of the transactions above have a status “200” (or “OK”) returned, which indicates that the y were successful.

FIG. 5 shows an example operational flow for implementing operational block 303 of FIG. 3 for determining performance data for a web page access. As described above, when a client clicks a hypertext link to retrieve an HTML file, the browser first establishes a TCP connection with the web server by sending a SYN packet. If the server is ready to process the request, it accepts the connection by acknowledgment of the client's SYN. The exchange of the SYN packets is the beginning of a connection. Then, the browser begins to send an HTTP request for the HTML file through the TCP connection. As described above, each object of a requested web page is retrieved from a server by an individual HTTP request made by the client.

A preferred embodiment uses the following functions to denote the critical timestamps for connection conn and request r:

t_{syn} (conn): time when the first SYN packet from the client is received by the server for establishing the connection conn;

| | |
|---|---|
| ${t}_{req}^{start} ( r ) \text{:}$ | time when the first byte of the request r is received by the server; |
| ${t}_{req}^{end} ( r ) \text{:}$ | time when the last byte of the request r is received by the server; |
| ${t}_{resp}^{start} ( r ) \text{:}$ | time when the first byte of the response for r is sent by the server; |
| ${t}_{resp}^{end} ( r ) \text{:}$ | time when the last byte of the response for r is sent by the server; and |
| ${t}_{req}^{ack} ( r ) \text{:}$ | time when the ACK for the last byte of the response for r is received by the server. |

It should be understood that the metrics introduced herein for this preferred embodiment account for packet retransmission. However, if the retransmission happens on connection establishment (i.e., due to dropped SYNs), the metrics of this embodiment do not account for this.

Additionally, for a web page P, we have the following variables:

N: the number of distinct network connections, conn₁, . . . , conn_{N} (e.g., number of distinct TCP connections) used to retrieve the objects in the web page P (see e.g., operational block 500 of FIG. 5); and

$${r}_{1}^{k} , … , {r}_{{n}_{k}}^{k} :$$

the requests for the objects retrieved through the connection connₖ (k=1, . . . N), and ordered according to the time when they were received, i.e.,

$${t}_{req}^{ end} ( {r}_{1}^{k} ) \leq {t}_{req}^{ end} ( {r}_{2}^{k} ) \leq … \leq {t}_{req}^{ end} ( {r}_{{n}_{k}}^{k} ) .$$

FIG. 6 shows an example of a simplified scenario where a 1-object page is downloaded by the client: it shows the communication protocol for connection setup between the client and the server as well as the set of major timestamps collected by a preferred embodiment on the server side. The connection setup time measured on the server side is the time between the client SYN packet and the first byte of the client request. This represents a close approximation for the original client setup time. This point is discussed further in conjunction with the case studies and validation experiments that we have conducted, as described below.

If the ACK for the last byte of the client response is not delayed or lost,

$${t}_{resp}^{ ark} ( r )$$

is a more accurate approximation of the end-to-end response time observed by the client rather than

$${t}_{resp}^{ end} ( r ) .$$

When

$${t}_{resp}^{ ark} ( r )$$

is considered as the end of a transaction, it “compensates” for the latency of the first client SYN packet that is not measured on the server side. The difference between the two methods (which may be referred to as the EtE time (last byte) and EtE time (ack) methods, respectively) is only a round trip time, which is on the scale of milliseconds. Since the overall response time is on the scale of seconds, we consider this deviation an acceptably close approximation. To avoid the problems with delayed or lost ACKs, a preferred embodiment uses the time when the last byte of a response is sent by a server as the end of a transaction. Thus in the following formulae, we use

$${t}_{resp}^{ end} ( r )$$

to calculate the response time.

The extended version of HTTP 1.0 and later version HTTP 1.1 introduce the concept of persistent connections and pipelining. See R T. Fielding, J. Gettys, J. Mogul, H. Nielsen, and T. Berners-Lee, “Hypertext Transfer Protocol—HTTP/1.l”, RFC 2068, IETF, January 1997 (available at http://www.w3.org/Protocols/rfc2068/rfc2068). Persistent connections enable reuse of a single TCP connection for multiple object retrievals from the same IP address (typically embedded objects of a web page). Pipelining allows a client to make a series of requests on a persistent connection without waiting for the previous response to complete (the server, however, returns the responses in the same order as the requests are sent).

As shown in FIG. 5, in a preferred embodiment all distinct network connections, conn₁, . . . , conn_{N} (e.g., number of distinct TCP connections) that are used to retrieve the objects of a web page P are determined in operational block 500. In operational block 501 of FIG. 5, pipelining groups, if any, comprising transactions of each connection of a common client access of a server are determined. In a preferred embodiment, we consider the requests

$${r}_{i}^{k} , … , {r}_{{n}_{k}}^{k}$$

to belong to the same pipelining group (denoted as

$$( denoted as PipeGr = \{ {r}_{1}^{k} , … , {r}_{{n}_{k}}^{k} \} )$$

if for any j such that i

$$i \leq j - 1 < j \leq n , {t}_{req}^{ start} ( {r}_{j}^{k} ) \leq {t}_{resp}^{ end} ( {r}_{j - 1}^{k} ) .$$

Thus for all the requests on the same connection connₖ:

$${r}_{1}^{k} , … , {r}_{{n}_{k}}^{k} ,$$

we define the maximum pipelining groups in such a way that they do not intersect, e.g.,

$$\underbrace{{r}_{1}^{k} , … , {r}_{i}^{k}}_{{PipeGr}_{1}} , \underbrace{{r}_{i + 1}^{k}}_{{PipeGr}_{2}} , … , \underbrace{{r}_{{n}_{k}}^{k}}_{{PipeGr}_{i}} .$$

In operational block 502, the main latency components are determined for each pipelining group. That is, for each of the pipelining groups, three portions of response time are defined in a preferred embodiment: 1) total response time (Total), 2) network-related portion (Network), and 3) lower-bound estimate of the server processing time (Server).

Let us consider the following example. For convenience, let us denote

$${PipeGr}_{1} = \{ {r}_{1}^{k} , … , {r}_{i}^{k} \} , then$$

$$\begin{matrix}\begin{matrix}Total ( {PipeGr}_{1} ) = {t}_{resp}^{ end} ( {r}_{i}^{k} ) - {t}_{req}^{ start} ( {r}_{1}^{k} ) , \\ Network ( {PipeGr}_{1} ) = {\sum }_{j = 1}^{i} ( {t}_{resp}^{ end} ( {r}_{j}^{k} ) - {t}_{resp}^{ start} ( {r}_{j}^{k} ) ) , and\end{matrix} \\ Server ( {PipeGr}_{1} ) = Total ( {PipeGr}_{1} ) - Network ( {PipeGr}_{1} ) .\end{matrix}$$

If no pipelining exists, the pipelining groups consist of one request only. In this case, the computed server time represents precisely the server processing time for a given request-response pair (or transaction). In order to better understand which information and measurements are extracted in a preferred embodiment from the timestamps observed at the server side for pipelined requests, let us consider FIG. 7 showing an example of communication between a client issuing a pipelined group of two requests and the server. This interaction comprises:

the connection setup between the client and the server;

two subsequent requests r1 and r2 issued by the client (these requests are issued as a pipelining group); and

the server responses for r1 and r2 are sent in the order the client requests were received by the server.

The timestamps collected at the server side reflect the time when the requests r1 and r2 were received by the server:

$${t}_{req}^{ start} ( r1 ) and {t}_{req}^{ start} ( r2 ) ;$$

as well as the time when the first byte of the corresponding responses were sent by the server:

$${t}_{resp}^{ start} ( r1 ) and {t}_{resp}^{ start} ( r2 ) .$$

However, according to the HTTP 1.1 protocol, the response for r2 can be sent only after the response for r1 being sent by the server. The time duration between the

$${t}_{req}^{ start} ( r2 ) and {t}_{resp}^{ start} ( r2 )$$

is indicative of the time delay on a server side before the response for r2 was sent to the client. However, the true server processing time for this request might be lower: it might have been prepared and was waiting for its turn (according to the HTTP 1.1 protocol requirements) to be sent to the client. The network portion of the response time for the pipelining group is defined by the sum of the network delays for the corresponding responses. This network portion of the delay defines the critical delay component in the response time.

In a preferred embodiment, we choose to account as server processing time only the server time that is explicitly exposed on the connection. If a connection adopts pipelining, the “real” server processing time might be larger than the computed server time because it can partially overlap with the network transfer time, and it is difficult to estimate the exact server processing time from the packet-level information. However, we are still interested to estimate the “non-overlapping” server processing time as this is the portion of the server time on a critical path of overall end-to-end response time. Thus, we use, as an estimate, the lower-bound server processing time, which is explicitly exposed in the overall end-to-end response.

Next, the connection setup time for each connection is determined. For instance, the client-perceived end-to-end time for retrieving a web page may include a certain amount of setup time for establishing the TCP connection with the server. In a preferred embodiment, if connection connₖ is a newly established connection to retrieve a web page, we observe additional connection setup time:

$$Setup ( {conn}_{k} ) = {t}_{req}^{ start} ( {r}_{1}^{k} ) - {t}_{syn} ( {conn}_{k} ) .$$

Otherwise the setup time is 0, as it is already established. Additionally, we define

$${t}^{start} ( {conn}_{k} ) = {t}_{syn} ( {conn}_{k} )$$

for a newly established connection, otherwise,

$${t}^{start} ( {conn}_{k} ) = {t}_{req}^{ start} ( {r}_{1}^{k} ) .$$

For each connection, the total time, as well as the portion of the total time that is attributable to server latency and the portion that is attributable to network latency, is computed, in operational block 503. For example, in a preferred embodiment, we define the latency breakdown for a given connection connₖ as:

$$\begin{matrix}\begin{matrix}Total ( {conn}_{k} ) = Setup ( {conn}_{k} ) + {t}_{resp}^{ end} ( {r}_{{n}_{k}}^{k} ) - {t}_{req}^{ start} ( {r}_{1}^{k} ) , \\ Network ( {conn}_{k} ) = Setup ( {conn}_{k} ) + {\sum }_{j = 1}^{l} Network ( {PipeGr}_{j} ) , and\end{matrix} \\ Server ( {conn}_{k} ) = {\sum }_{j = 1}^{l} Server ( {PipeGr}_{j} ) .\end{matrix}$$

In operational block 504, the response time is determined for a given page “P” that is accessed via client connection(s) under consideration, which may comprise multiple concurrent connections). In operational block 505, the portion of the response time that is attributable to server latency and the portion that is attributable to network latency are determined. The latencies for a given page P may be defined in a preferred embodiment as:

$$\begin{matrix}\begin{matrix}Total ( P ) = {max}_{j \leq N} {t}_{resp}^{ end} ( {r}_{{n}_{j}}^{j} ) - {min}_{j \leq N} {t}^{start} ( {conn}_{j} ) , \\ CumNetwork ( P ) = {\sum }_{j = 1}^{N} Network ( {conn}_{j} ) , and\end{matrix} \\ CumServer ( P ) = {\sum }_{j = 1}^{N} Server ( {conn}_{j} ) .\end{matrix}$$

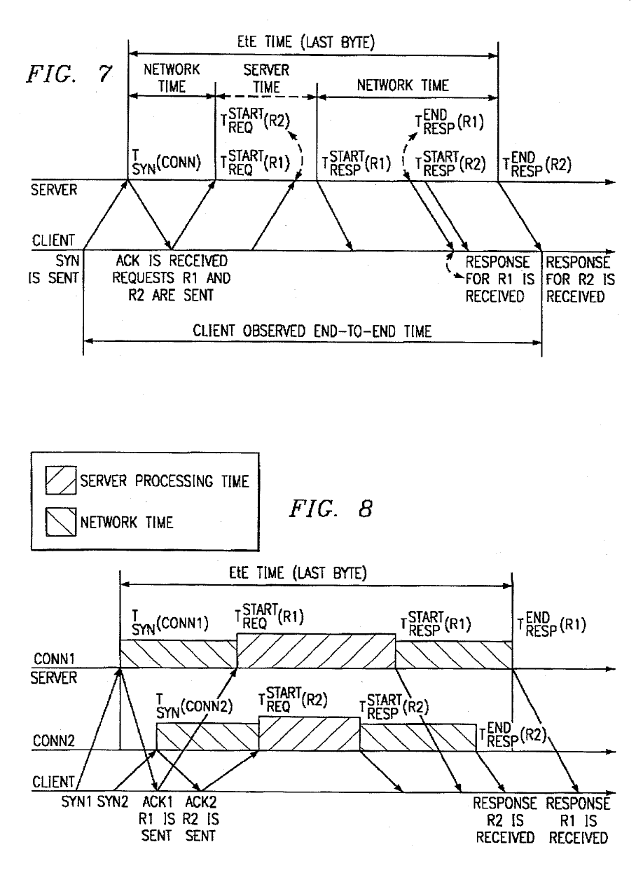

Hereafter, the term EtE time may be used interchangeably with Total(P) time. The functions CumNetwork(P) and CumServer(P) above give the sum of all the network-related and server processing portions of the response time over all connections used to retrieve the web page. However, the connections can be opened concurrently by the browser as shown in FIG. 8, and the server processing time portion and network transfer time portion on different concurrent connections may overlap. To evaluate the concurrency (overlap) impact in a preferred embodiment, we introduce the page concurrency coefficient ConcurrencyCoef(P):

$$ConcurrencyCoef ( P ) = \frac{{\sum }_{j = 1}^{N} Total ( {conn}_{j} )}{Total ( p )} .$$

Using page concurrency coefficient, we finally compute the network-related and the server-related portions of response time for a particular page P:

Network(P)=CumNetwork(P)/ConcurrencyCoef (P),

Server(P)=CumServer(P)/ConcurrencyCoef (P).

Understanding this breakdown between the network-related and server-related portions of response time may be desired for future service optimizations. It also helps to evaluate the possible impact on end-to-end response time improvements due to server-side optimization. Clearly, the end-to-end response time improvement due to server-side optimization might be limited by the Server(P) time.

Further, a preferred embodiment can distinguish the requests sent to a web server from clients behind proxies by checking the HTTP via fields. If a client page access is handled via the same proxy (which is typically the case, especially when persistent connections are used), a preferred embodiment provides correct measurements for end-to-end response time and other metrics, as well as provides interesting statistics on the percentage of client requests coming from proxies. Clearly, this percentage is an approximation, since not all proxies set the via fields in their requests. The embodiment described above measures the response time to a proxy, instead of to the actual client behind it.

As shown in operational block 506 of FIG. 5, a preferred embodiment may further determine the caching efficiency of a client access. Real clients of a web service may benefit from the presence of network and browser caches, which can significantly reduce their perceived response time. However, none of the existing performance measurement techniques of the prior art provide any information on the impact of caches on web services: what percentage of the files and bytes are delivered from the server compared with the total files and bytes required for delivering the web service. In the prior art, the caching impact can only be partially evaluated from web server logs by checking response status code “304,” whose corresponding requests are sent by the network caches to validate whether the cached object has been modified. If the status code 304 is set, the cached object is not expired and need not be retrieved again.

To evaluate the caching efficiency of a web service in a preferred embodiment of the present invention, we introduce two metrics: 1) server file hit ratio and 2) server byte hit ratio for each web page. For a web page P, assume the objects composing the page are O₁ , . . . , Oₙ. Let SizeOᵢ denote the size of object Oᵢ in bytes. Then we define

$$NumFiles ( P ) = n and Size ( P ) = {\sum }_{j = 1}^{n} Size ( {O}_{j} ) .$$

Additionally, for each access

$${P}_{access}^{i}$$

of the page P, assume the objects retrieved in the access are

$${O}_{1}^{i} , … , {O}_{{k}_{i}}^{i} ,$$

we define NumFiles

$${P}_{access}^{i} = {k}_{i} and Size {P}_{access}^{i} = {\sum }_{j = 1}^{{k}_{i}} Size ( {O}_{j}^{i} ) .$$

First, we define file hit ratio and byte hit ratio for each page access in the following way:

$$\begin{matrix}FileHitRatio ( {P}_{access}^{i} ) = NumFiles ( {P}_{access}^{i} ) / NumFiles ( P ) , and \\ ByteHitRatio ( {P}_{access}^{i} ) = Size ( {P}_{access}^{i} ) / Size ( P ) .\end{matrix}$$

$$Let {P}_{access}^{1} , … , {P}_{access}^{N}$$

be all the accesses to the page P during the observed time interval. Then

$$\begin{matrix}ServerFileHitRatio ( P ) = \frac{1}{N} {\sum }_{k \leq N}^{} FileHitRatio ( {P}_{access}^{k} ) , and \\ ServerByteHitRatio ( P ) = \frac{1}{N} {\sum }_{k \leq N}^{} ByteHitRatio ( {P}_{access}^{k} ) .\end{matrix}$$

The lower the numbers for server file hit ratio and server byte hit ratio, the higher the caching efficiency for the web service, i.e., more files and bytes are served from network and client browser caches.

Evaluation of caching efficiency may be helpful to site designers. For example, a corporate web site often has a set of templates, buttons, logos, and shared images that are actively reused among a set of different pages. A user, browsing through such a site, can clearly benefit from the browser cache. The above-described caching metrics are useful to evaluate the efficiency of caching and compare different site designs.

To exemplify how a preferred embodiment of the present invention may be used to assess web site performance, we now present two simple case studies that we have conducted. The first study was of the HP Labs external web site (HPL Site), http.//www.hpl.hp.com. Static web pages comprise most of this site's content. We measured performance of this site for a month, from Jul. 12, 2001 to Aug. 11, 2001. The second study was of a support site for a popular HP product family, which we call Support Site. It uses JavaServer Pages technology for dynamic page generation. (For more information regarding JavaServer Pages See http://www.java.sun.com/products/jsp/technical.html). The architecture of this site is based on a geographically distributed web server cluster with Cisco Distributed Director for load balancing, using “sticky connections” or “sticky sessions”, i.e. once a client has established a TCP connection with a particular web server, the subsequent client's requests are sent to the same server. We measure the site performance for 2 weeks, from Oct. 11, 2001 to Oct. 25, 2001.

Table 2 below summarizes the two site's performance at-a-glance during the measured period using the two most frequently accessed pages at each site.

TABLE 2

| Metrics | HPL url1 | HPL url2 | Support url1 | Support url2 |
|---|---|---|---|---|
| EtE time | 3.5 sec | 3.9 sec | 2.6 sec | 3.3 sec |
| % of accesses above 6 sec | 8.2% | 8.3% | 1.8% | 2.2% |
| % of aborted accesses above 6 sec | 1.3% | 2.8% | 0.1% | 0.2% |
| % of accesses from clients-proxies | 16.8% | 19.8% | 11.2% | 11.7% |
| EtE time from clients-proxies | 4.2 sec | 3 sec | 4.5 sec | 3 sec |
| Network-vs-Server ratio in EtE time | 99.6% | 99.7% | 96.3° 10 | 93.5% |
| Page size | 99 KB | 60.9 KB | 127 KB | 100 KB |
| Server file hit ratio | 38.5% | 58% | 22.9% | 28.6% |
| Server byte hit ratio | 44.5% | 63.2% | 52.8% | 44.6% |
| Number of objects | 4 | 2 | 32 | 32 |
| Number of connections | 1.6 | 1 | 6.5 | 9.1 |

The average end-to-end response tine of client accesses to these pages reflects good overall performance. However in the case of HPL, a sizeable percentage of accesses take more than 6 seconds to complete (8.2%-8.3%), with a portion leading to aborted accesses (1.3%-2.8%). For more information about relating aborted accesses to server quality of service (QoS), see concurrently filed and commonly assigned U.S. patent application Ser. No. ______ entitled “SYSTEM AND METHOD FOR RELATING ABORTED CLIENT ACCESSES OF DATA TO QUALITY OF SERVICE PROVIDED BY A SERVER IN A CLIENT-SERVER NETWORK”, the disclosure of which is incorporated herein by reference. The Support site had better overall response time with a much smaller percentage of accesses above 6 seconds (1.8%-2.2%), and a correspondingly smaller percentage of accesses aborted due to high response time (0.1%-0.2%).

Overall, the pages from both sites are comparable in size. However, the two pages from the HPL site have a small number of objects per page (4 and 2 correspondingly), while the Support site pages are composed of 32 different objects. In general, page composition influences the number of client connections required to retrieve the page content. Additionally, statistics show that network and browser caches help to deliver a significant amount of page objects: in the case of the Support site, only 22.9%-28.6% of the 32 objects are retrieved from the server, accounting for 44.6%-52.8% of the bytes in the requested pages. As discussed earlier, the Support site content is generated using dynamic pages, which could potentially lead to a higher ratio of server processing time in the overall response time. But in general, the network transfer time dominates the performance for both sites, ranging from 93.5% for the Support site to 99.7% for the HPL site.

Given the above summary, we now present more detailed information from our site measurements. For the HPL site, the two most popular pages (during the observed period were index.html and a page in the news section describing the Itanium chip (we call it itanium.html).

FIG. 9A shows a graph illustrating the end-to-end response time for accesses to index.html on an hourly scale during a month. In spite of good average response time reported in at-a-glance table, hourly averages reflect significant variation in response times. This graph helps to stress the advantages of a preferred embodiment of the present invention and reflects the shortcomings of active probing techniques that measure page performance only a few times per hour: the collected test numbers could vary significantly from a site's instantaneous performance characteristics.

FIG. 9B shows a graph illustrating the number of resent packets in the response stream to clients. There are three pronounced “humps” with an increased number of resent packets. Typically, resent packets reflect network congestion or the existence of some network-related bottlenecks. Interestingly enough, such periods correspond to weekends when the overall traffic is one order of magnitude lower than weekdays. The explanation for this phenomenon is that during weekends the client population of the site “changes” significantly: most of the clients access the site from home using modems or other low-bandwidth connections. This leads to a higher observed end-to-end response time and an increase in the number of resent packets (i.e., TCP is likely to cause drops more often when probing for the appropriate congestion window over a low-bandwidth link). These results again stress the unique capabilities of a preferred embodiment to extract appropriate information from network packets, and reflect another shortcomings of active probing techniques that use a fixed number of artificial clients with rather good network connections to the Internet. For site designers, it is important to understand the actual client population and their end-to-end response time and the “quality” of the response. For instance, when a large population of clients have limited bandwidth parameters, the site designers should consider making the pages and their objects “lighter weight”.

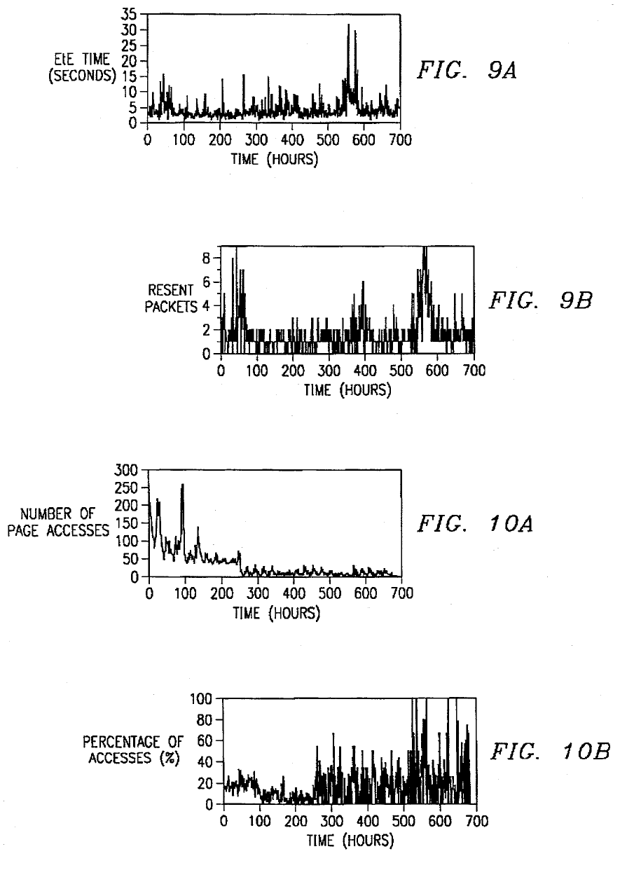

FIG. 10A shows a graph illustrating the number of page accesses to itanium.html. When we started our measurement of the HPL site, the itanium.html page was the most popular page, “beating” the popularity of the main index. html page. However, ten days later, this news article started to get “colder”, and the page fell to seventh place in popularity.

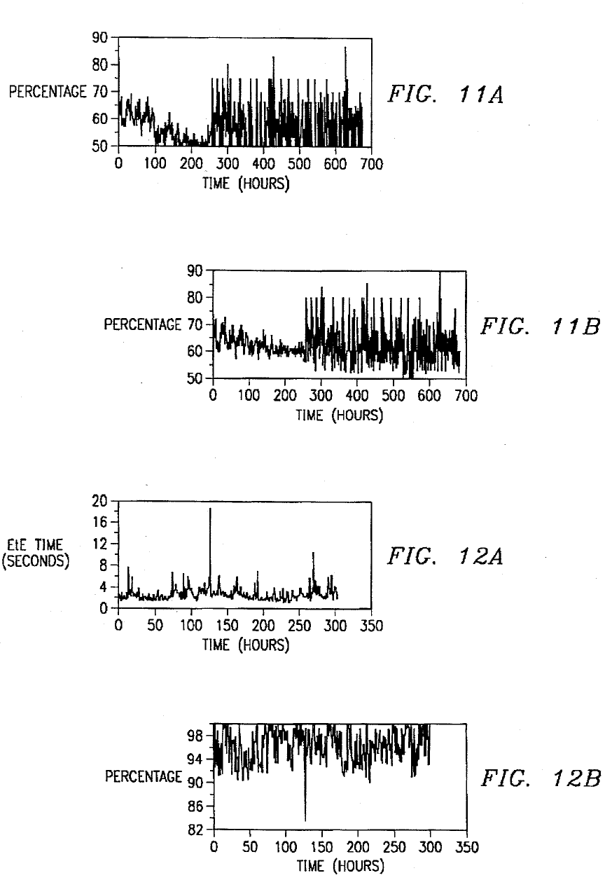

FIG. 10B shows a graph illustrating the percentage of accesses with end-to-end response time above 6 seconds. As described above, most website providers currently set a target client-perceived end-to-end time of less than six seconds for their web pages. As shown in the example of FIG. 10B, the percentage of high response time jumps significantly when the page becomes “colder”. The reason behind this phenomenon is shown in FIGS. 11A and 11B, which plot the server file hit and byte hit ratios, respectively. When the page became less popular, the number of objects and the corresponding bytes retrieved from the server increased significantly. This reflects that fewer network caches store the objects as the page becomes less popular, forcing clients to retrieve them from the origin server.

FIGS. 10A-10B and 11A-11B explicitly demonstrate the network caching impact on end-to-end response time. When the caching efficiency of a page is higher (i.e., more page objects are cached by network and browser caches), the response time is generally lower. Again, active probing techniques of the prior art cannot measure (or account for) the page caching efficiency to reflect the “true” end-to-end response time observed by actual clients.

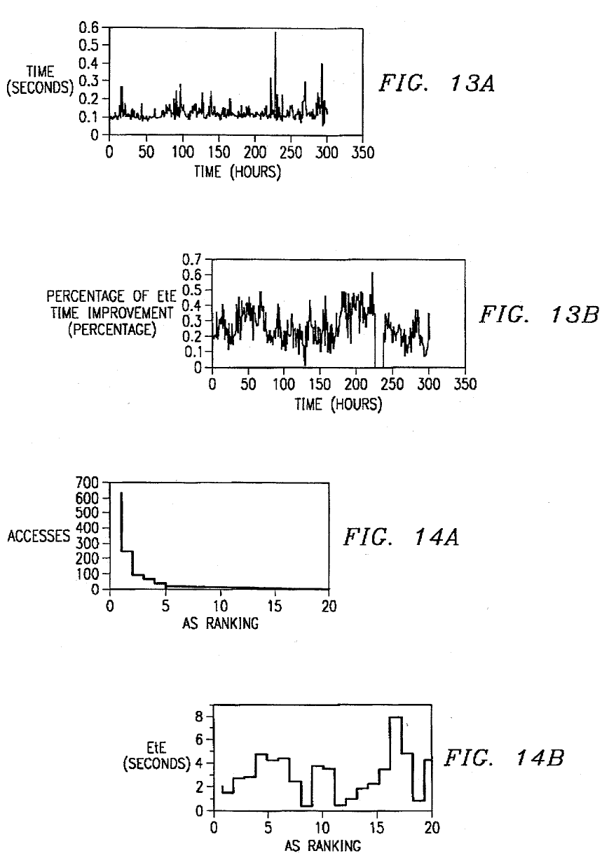

Turning to the analysis of the Support site, we highlight some of our observations regarding this site. FIG. 12A shows a graph illustrating the average end-to-end response time as measured by a preferred embodiment when downloading the site main page. This site uses JavaServer Pages technology for dynamic generation of the content. Since dynamic pages are typically more “compute intensive,” it has a corresponding reflection in higher server-side processing fraction in overall response time. FIG. 12B shows a graph illustrating the network-server time ratio in the overall response time. It is higher compared to the network-server ratio for static pages from the HPL site. One interesting detail is that the response time spike around the 127 hour mark has a corresponding spike in increased server processing time, indicating some server-side problems at this point. Accordingly, the performance data provided by a preferred embodiment may help service providers to better understand site-related performance problems.

The Support site pages are composed of a large number of embedded images. Two most popular site pages, which account for almost 50% of all the page accesses, consist of 32 objects. The caching efficiency for the site is very high: only- 8-9 objects are typically retrieved from the server, while the other objects are served from network and browser caches. The site server is running HTTP 1.0 server. Thus typical clients used 7-9 connections to retrieve 8-9 objects. The ConcurrencyCoef (as described above), which reflects the overlap portion of the latency between different connections for this page, was very- low, around 1.038 (in fact, this is true for the site pages in general). This indicates that the efficiency of most of these connections is almost equal to sequential retrievals through a single persistent connection.

FIG. 13A shows a graph illustrating the connection setup time measured by a preferred embodiment. We performed a relatively simple computation to determine how much of the end-to-end response time observed by current clients can be improved if the site server would run an HTTP 1.1 server, allowing clients to use just two persistent connections to retrieve the corresponding objects from the site. In other words, we determine how much of the response time can be improved by eliminating unnecessary connection setup time.

FIG. 13B shows a graph illustrating the estimated percentage of end-to-end response time improvement available from running an HTTP 1.1 server. On average, during the observed interval, the response time improvement for url1 is around 20% (2.6 sec is decreased to 2.1 sec), and for url2 is around 32% (3.3 sec is decreased to 2.2 sec).

FIG. 13B reveals an unexpected “gap” between 230-240 hour marks, when there was “no improvement” due to HTTP 1.1. More careful analysis shows that during this period, all the accesses retrieved only a basic HTML page using one connection, without consequent image retrievals. The other pages during the same interval have a similar pattern. It looks like the image directory was not accessible on the server. Thus, by exposing the abnormal access patterns, a preferred embodiment can help service providers gain additional insight into service related problems and make decisions as to how to change a site's implementation for improved performance.

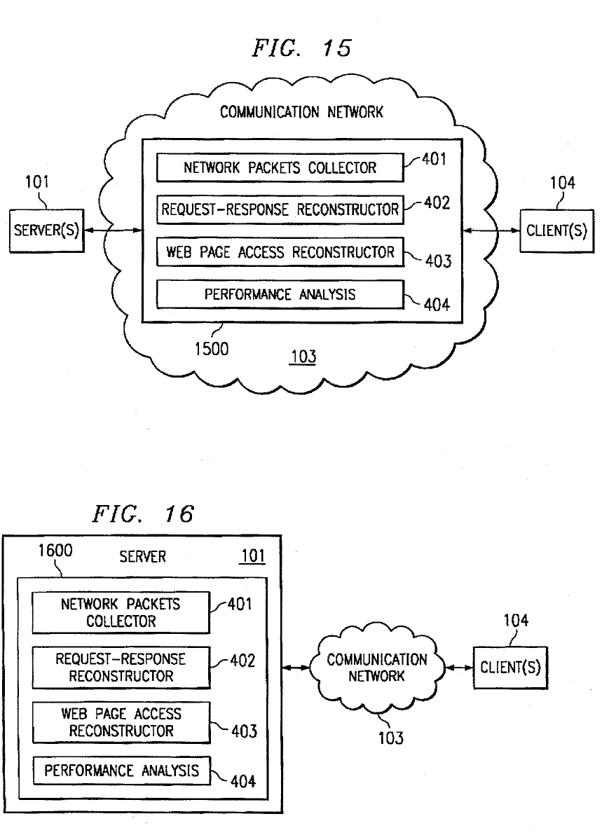

A preferred embodiment may also provide information about client clustering by associating them with various ASes (Autonomous Systems). FIG. 14A shows a graph illustrating the 20 largest client clusters by ASes. FIG. 14B shows a graph that reflects the corresponding average end-to-end response time per AS. The information provides a useful quantitative view on response times to the major client clusters. It can be used for efficient site design when the geographically distributed web cluster is needed to improve site performance. Similarly, such information can be used to make appropriate decisions on specific content distribution networks and wide-area replication strategies given a particular service's client population.

The ability of a preferred embodiment to reflect a site performance for different ASes (and groups of IP addresses) happens to be a very attractive feature for service providers. When service providers have special Service Level Agreement (SLA) contracts with certain groups of customers, a preferred embodiment provides a unique ability to measure the response time observed by those clients and validate the quality of service (QoS) for those contracts (e.g., whether a specified level of performance is provided).

Finally, we present a few performance numbers to reflect the execution time of a preferred embodiment when processing data for the HPL and Support sites in the above-described studies. The tests were run on a 550 Mhz HP C3600 workstation with 512 MB of RAM. Table 3 below presents the amount of data and the execution time for processing 10,000,000 TCP Packets.

TABLE 3

| Duration, Size, | | |
|---|---|---|
| and Execution Time | HPL site | Support site |
| Duration of data collection | 3 days | 1 day |
| Collected data size | 7.2 GB | 8.94 G13 |
| Transaction Log size | 35 MB | 9.6 MB |
| Entries in Transaction Log | 616,663 | 157,200 |
| Reconstructed page accesses | 90,569 | 8,642 |
| Reconstructed pages | 5,821 | 845 |
| EtE Execution Time | 12 min 44 sec | 17 min 41 see |

We performed two groups of experiments to validate the accuracy of the performance measurements of a preferred embodiment of the present invention. In the first experiment, we used two remote clients residing at Duke University and Michigan State University to issue a sequence of 40 requests to retrieve a designated web page from HPLabs external web site, which consists of an HTML file and 7 embedded images. The total page size is 175 Kbytes. To issue these requests, we use httperf, a tool which measures the connection setup time and the end-to-end time observed by the client for a full page download. (For more information regarding httperf, See D. Mosberger and T. Jin, “Httperf—A Tool for Measuring Web Server Performance”, J of Performance Evaluation Review, Vol. 26, Number 3, December 1998). At the same time, a preferred embodiment of the present invention (referred to as “EtE Monitor”) measured the performance of HPLabs external web site. From the measurements of a preferred embodiment, we filter the statistics about the designated client accesses. Additionally, the EtE Monitor was used to compute the end-to-end time using two slightly different approaches from those discussed above:

EtE time (last byte): where the end of a transaction is the time when the last byte of the response is sent by a server; and

EtE time (ACK): where the end of a transaction is the time when the ACK for the last byte of the response is received.

Table 4 summarizes the results of this experiment (the measurements are given in seconds):

| | |
|---|---|
| Httperf | EtE monitor |

| | Conn | Resp. | Conn | EtE time | ETE time |
|---|---|---|---|---|---|
| Client | Setup | Time | Setup | (last byte) | (ACK) |
| Michigan | 0.074 | 1.027 | 0.088 | 0.953 | 1.026 |
| Duke | 0.102 | 1.38 | 0.117 | 1.28 | 1.38 |

The connection setup time reported by the EtE monitor was slightly higher (14-15 ms) than the actual setup time measured by httperf, since it includes the time to not only establish a TCP connection but also receive the first byte of a request. The EtE time (ACK) coincides with the actual measured response time observed by the client. The EtE time (last byte) is slightly lower than the actual response time by exactly a round trip delay (the connection setup time measured by httperf represents the round trip time for each client, accounting for 74-102 ms). These measurements correctly reflect our expectations of accuracy. Thus, a preferred embodiment of the present invention may be used to accurately approximate the actual response time observed by a client.

Embodiments of the present invention are preferably implemented on the server side of a client-server network for determining performance data relating to client accesses of server information (e.g., web pages). For instance, embodiments of the present invention are preferably implemented such that network-level information is captured on the server side of the client-server network, and as described above, such network-level information may be used to reconstruct client accesses and measure performance metrics (e.g., end-to-end response time, server latency, network latency, caching efficiency, etc.) for such client accesses.

It should be understood that the modules of FIG. 4 for reconstructing web page accesses and/or analyzing performance of such accesses may be deployed in several different ways on the server side of a client-server network. As used herein, the “server side” of a client-server network is not intended to be limited solely to the server itself, but is also intended to comprise any point in the client-server network at which all of the traffic “to” and “from” the server (e.g., a web server cluster or a particular web server in a cluster) that is used to support the monitored web site (or other type of monitored information that is accessible by a client) can be observed (e.g., to enable capture of the network packets communicated to/from the server). Various examples of server-side implementations are described herein below. As one example, the modules may be implemented as an independent network appliance for reconstructing web page accesses (and, in certain implementations, measuring end-to-end performance). An example of such a network appliance implementation is shown in FIG. 15. As shown, one or more servers 101 (e.g., servers 101A-101D of FIG. 1) may be provided for serving information (e.g., web pages) to one or more clients 104 (e.g., clients 104A-104 of FIG. 1) via communication network 103. Web page access performance monitor appliance 1500 may be arranged at a point in communication network 103 where it can capture all HTTP transactions for server(s) 101, e.g., the same subnet of server(s) 101. In this implementation, access performance monitor appliance 1500 should be arranged at a point in network 103 where traffic in both directions can be captured for server(s) 101: the request traffic to server(s) 101, and the response traffic from server(s) 101. Thus, if a web site consists of multiple web servers 101, appliance 1500 should be placed at a common entrance and exit of all such web servers 101.

If a web site is supported by geographically distributed web servers, such a common point may not exist in network 103. However, most typically, web servers in a web server farm (or cluster) use “sticky connections”, i.e., once the client, has established a TCP connection with a particular web server, the consequent client's requests are sent to the same server. In this case, implementing appliance 1500 can still be used to capture a flow of transactions (to and from) a particular web server 101, representing a part of all web transactions for the web site, and the measured data can be considered as sampling.

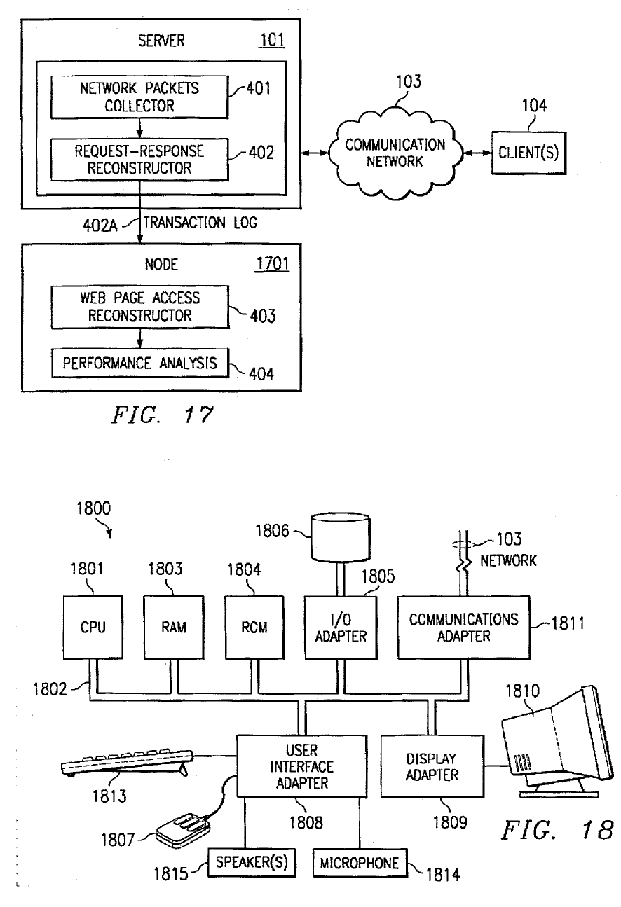

As another example of how the modules of FIG. 4 may be deployed, they may be implemented as a software solution deployed on a web server. An example of such a software solution is shown in FIG. 16. As shown, server 101 may be provided for serving information (e.g., web pages) to one or more clients 104 via communication network 103. Web page access performance monitor software 1600 may be implemented as a software solution at server 101, and used for reconstructing transactions and/or measuring performance (e.g., end-to-end performance) at this particular server.

If a web site consists of multiple web servers, then as in the previous case, this software solution still can work when each web server is using “sticky connections.” In this case, the software solution 1600 can be installed at a randomly selected web server 101 in the overall site configuration, and the measured data can be considered as sampling.

As another example of how the modules of FIG. 4 may be deployed, they may be implemented as a mixed software solution with some modules deployed on a web server and some modules deployed on an independent node, outside of a web server complex. An example of such a mixed software solution is shown in FIG. 17. As shown, server 101 may be provided for serving information (e.g., web pages) to one or more clients 104 via communication network 103. A portion of the web page access performance monitor solution (e.g., certain modules) may be implemented at server 101, and the rest (e.g., the remaining modules) may be implemented at an independent node.

For example, to minimize the performance impact of additional computations on server 101, only two modules are deployed at server 101 in the example of FIG. 17, i.e., network packets collector module 401 and request-response reconstructor module 402. The outcome of request-response reconstructor module 402 is a Transaction Log 402A that is preferably two orders of magnitude smaller than the original Network Trace 401A. Such Transaction Log 402A is transferred to a different, independent node 1701 installed with web page access reconstructor module 403 and performance analysis module 404. These modules process the Transaction Logs received from web server(s) 101 to reconstruct web page accesses and generate performance analysis (e.g., end-to-end performance measurements).

It should be noted that in each of the implementations described above in FIGS. 15-17, the solutions exclude from consideration the encrypted connections whose content cannot be analyzed, and hence, the HTTP-level information cannot be extracted. That is, because embodiments of the present invention preferably capture network-level information and utilize such network-level information for reconstructing web page accesses, encrypted connections are not analyzed.

When implemented via computer-executable instructions, various elements of the present invention, such as modules 401-404 of FIG. 4, are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information.

FIG. 18 illustrates an example computer system 1800 adapted according to embodiments of the present invention. In certain embodiments of the present invention, computer system 1800 is a web server on which computer executable code may be implemented for performing performance analysis of client accesses of server information. Central processing unit (CPU) 1801 is coupled to system bus 1802. CPU 1801 may be any general purpose CPU. Suitable processors include without limitation INTEL's PENTIUM® 4 processor, for example. However, the present invention is not restricted by the architecture of CPU 1801 as long as CPU 1801 supports the inventive operations as described herein. CPU 1801 may execute the various logical instructions according to embodiments of the present invention. For example, CPU 1801 may execute machine-level instructions according to the exemplary operational flows described above in conjunction with FIGS. 3 and 5. As another example, CPU 1801 may execute machine-level instructions for computing the various performance measurements described herein above.

Computer system 1800 also preferably includes random access memory (RAM) 1803, which may be SRAM, DRAM, SDRAM, or the like. Computer system 1800 may utilize RAM 1803 to store the Network Trace 401A, Transaction Log 402A, and/or Web Page Session Log 403A, as examples. Computer system 1800 preferably includes read-only memory (ROM) 1804 which may be PROM, EPROM, EEPROM, or the like. RAM 1803 and ROM 1804 hold user and system data and programs as is well known in the art.

Computer system 1800 also preferably includes input/output (I/O) adapter 1805, communications adapter 1811, user interface adapter 1808, and display adapter 1809. I/O adapter 1805 and/or user interface adapter 1808 may, in certain embodiments, enable a user to interact with computer system 1800 in order to input information.

I/O adapter 1805 preferably connects to storage device(s) 1806, such as one or more of hard drive, compact disc (CD) drive, floppy disk drive, tape drive, etc. to computer system 1800. The storage devices may be utilized when RAM 1803 is insufficient for the memory requirements associated with storing data for reconstructing web page accesses. Communications adapter 1811 is preferably adapted to couple computer system 1800 to network 103. User interface adapter 1808 couples user input devices, such as keyboard 1813, pointing device 1807, and microphone 1814 and/or output devices, such as speaker(s) 1815 to computer system 1800. Display adapter 1809 is driven by CPU 1801 to control the display on display device 1810.

It shall be appreciated that the present invention is not limited to the architecture of system 1800. For example, any suitable processor-based device may be utilized, including without limitation personal computers, laptop computers, computer workstations, and multi-processor servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

While various embodiments described above are implemented for determining end-to-end performance for a client access of server information (e.g., a web page), it should be understood that other performance data relating to client accesses may be measured in alternative embodiments. Thus, the present invention is not intended to be limited solely to measuring end-to-end performance, but rather such performance measurement is intended as an example for rendering the disclosure enabling for other performance measurements relating to client accesses of server information. Preferably, network-level information (e.g., network packets) for a client access of server information (e.g., a web page) is captured through a passive technique on the server side of the client-server network, and such network-level information may be used to determine various types of performance measurements relating to the client access. Any type of measurement capable of being determined from the network-level information, either directly or indirectly (e.g., through computations using such network-level information), are intended to be within the scope of the present invention.

In certain embodiments, a plurality of transactions that correspond to a given client access of server information (e.g., a web page) may be grouped together to enable analysis of performance of the given client access. That is, network-level information may be acquired for a plurality of transactions, and such plurality of transactions may be grouped into a corresponding client access of server information (e.g., a corresponding web page access). For instance, the network-level information acquired for the transactions may be used to reconstruct such transactions into their corresponding client access of server information. The network-level information for the grouped transactions may then be used for determining performance measurement(s), such as end-to-end performance, relating to the client access composed of such transactions.

What is claimed is:

1. A method for measuring performance of service provided to a client by a server in a client-server network, said method comprising:
capturing network-level information for a client access of data from a server in a client-server network, wherein said client-server network comprises a server side and a client side and wherein said network-level information is captured on said server side; and
determining from the captured network-level information at least one performance measurement relating to said client access of data.

2. The method of claim 1 wherein said at least one performance measurement comprises:
measurement of end-to-end performance of said client access of data.

3. The method of claim 2 wherein said end-to-end performance comprises a measurement of time from said client requesting said data to said client fully receiving said data.

4. The method of claim 2 wherein said at least one performance measurement further comprises:
measurement of a portion of said end-to-end performance that is attributable to network latency.

5. The method of claim 2 wherein said at least one performance measurement further comprises:
measurement of a portion of said end-to-end performance that is attributable to server latency.

6. The method of claim 2 wherein said at least one performance measurement further comprises:
measurement of caching efficiency for said client access of data.

7. The method of claim 6 wherein said caching efficiency comprises:
measurement of the number of files of said data that are retrieved from said server for said client access.

8. The method of claim 6 wherein said caching efficiency comprises:
measurement of the number of bytes of said data that are retrieved from said server for said client access.

9. The method of claim 1 wherein said at least one performance measurement comprises:
measurement of server latency during said client access of data.

10. The method of claim 1 wherein said client and server interact through a plurality of transactions for enabling said client access of said data.

11. The method of claim 1 wherein said data comprises a web page and said server comprises a web server.

12. The method of claim 1 wherein said network-level information comprises network packets.

13. A method for measuring performance of service provided to a client by a server in a client-server network, said method comprising:
capturing network-level information for a plurality of transactions between a client and a server, said plurality of transactions conducted for providing desired data to said client, wherein each of said plurality of transactions comprises a request from said client to said server and a response to said client from said server; and
determining from the captured network-level information at least one performance measurement relating to providing said desired data to said client.

14. The method of claim 13 wherein said at least one performance measurement comprises:
measurement of end-to-end performance of providing said desired data to said client.

15. The method of claim 14 wherein said at least one performance measurement further comprises:
measurement of a portion of said end-to-end performance that is attributable to server latency.

16. The method of claim 14 wherein said measurement of end-to-end performance comprises:
a measurement of time from said client requesting said desired data to said client fully receiving said desired data.

17. The method of claim 14 wherein said at least one performance measurement further comprises:
measurement of a portion of said end-to-end performance that is attributable to network latency.

18. The method of claim 14 wherein said at least one performance measurement further comprises:
measurement of caching efficiency of providing said desired data to said client.

19. The method of claim 18 wherein said caching efficiency comprises:
measurement of the number of files of said desired data that are retrieved from said server for providing said desired data to said client.

20. The method of claim 18 wherein said caching efficiency comprises:
measurement of the number of bytes of said desired data that are retrieved from said server for providing said desired data to said client.

21. The method of claim 13 wherein said desired data comprises a web page.

22. The method of claim 13 wherein said client-server network comprises a server side and a client side, and wherein said capturing network-level information comprises:
capturing said network-level information on said server side of said client-server network.

23. The method of claim 13 wherein said network-level information comprises network packets.

24. A method for measuring end-to-end performance of providing a requested web page to a client, said method comprising:
capturing, on a server side of a client-server network, network-level information for client accesses of at least one web page; and
using the captured network-level information to measure end-to-end performance in providing said at least one web page to a client.

25. The method of claim 24 wherein said end-to-end performance comprises a measurement of time from said client requesting said at least one web page to said client fully receiving said at least one web page.

26. The method of claim 24 further comprising:
using the captured network-level information to determine a portion of said end-to-end performance that is attributable to network latency.

27. The method of claim 24 further comprising:
using the captured network-level information to determine a portion of said end-to-end performance that is attributable to server latency.

28. The method of claim 24 further comprising:
using the captured network-level information to determine caching efficiency for said client accesses.

29. The method of claim 28 wherein said caching efficiency comprises:
measurement of the number of files of said at least one web page that are retrieved from said server for said client accesses.

30. The method of claim 28 wherein said caching efficiency comprises:
measurement of the number of bytes of said at least one web page that are retrieved from said server for said client accesses.

31. The method of claim 24 wherein said network-level information comprises network packets.

32. A system for measuring performance of serving a web page to a client in a client-server network, said system comprising:
server for communicating at least one web page to clients via a communication network to which said server is communicatively coupled;
means for capturing network-level information for client accesses of said at least one web page;
means for reconstructing, from said captured network-level information, said client accesses of said at least one web page; and
means for determining at least one performance measurement for at least one of the reconstructed client accesses.

33. The system of claim 32 wherein said client-server network comprises a server side and a client side, and wherein said means for capturing network-level information is arranged on said server side of said client-server network.

34. The system of claim 32 wherein a client access of said at least one web page comprises a plurality of transactions, and wherein said means for reconstructing said client accesses of said at least one web page comprises:
means for relating said plurality of transactions to their corresponding client web page access based at least in part on said captured network-level information for said plurality of transactions.

35. The system of claim 32 wherein said means for determining at least one performance measurement comprises:
means for determining measurement of end-to-end performance of said at least one of the reconstructed client accesses.

36. The system of claim 35 wherein said end-to-end performance comprises a measurement of time from a client requesting a web page to said client fully receiving said web page.

37. The system of claim 35 wherein said means for determining at least one performance measurement further comprises:
means for determining measurement of a portion of said end-to-end performance that is attributable to network latency.

38. The system of claim 35 wherein said means for determining at least one performance measurement further comprises:
means for determining measurement of a portion of said end-to-end performance that is attributable to server latency.

39. The system of claim 35 wherein said means for determining at least one performance measurement further comprises:
means for determining measurement of caching efficiency for said at least one of the reconstructed client accesses.

40. The system of claim 39 wherein said means for determining measurement of caching efficiency comprises:
means for determining measurement of the number of files of a web page that are retrieved from said server for said at least one of the reconstructed client accesses.

41. The system of claim 39 wherein said means for determining measurement of caching efficiency comprises:
means for determining measurement of the number of bytes of a web page that are retrieved from said server for said at least one of the reconstructed client accesses.
